(19) United States
(12) Patent Application Publication
(10) Pub. No.: US 2025/0356188 A1
(43) Pub. Date: Nov. 20, 2025

(54) NEURAL NETWORK FOR TABULAR DATA WITH NONLINEAR FILTERING

(71) Applicant: Royal Bank of Canada, Toronto (CA)

(72) Inventors: Yik Chau LUI, Toronto (CA); Yanshuai CAO, Toronto (CA); Cheng CHI, Toronto (CA)

(21) Appl. No.: 19/205,500

(22) Filed: May 12, 2025

Related U.S. Application Data
(60) Provisional application No. 63/647,474, filed on May 14, 2024.
(60) Provisional application No. 63/716,116, filed on Nov. 4, 2024.

(51) Int. Cl. G06N 3/08

(52) U.S. Cl. CPC G06N 3/08

(57) ABSTRACT

A computer-implemented method for training a neural network for processing tabular data, comprises training a neural network to generate hidden layer connections and hidden layer weights for the tabular data, and training a skip layer to constrain the neural network. The skip layer governs an extent to which particular features of the tabular data participate in the neural network. The skip layer is based on a nonlinear per-feature embedding for each feature of the tabular data.

### CROSS-REFERENCE TO RELATED APPLICATIONS

This application claims priority to, and the benefit of, U.S. Provisional Application No. 63/716,116 filed on Nov. 4, 2024 and U.S. Provisional Application No. 63/647,474 filed on May 14, 2024, the teachings of each of which are hereby incorporated by reference.

### TECHNICAL FIELD

The present disclosure relates to machine learning using neural networks, and particularly to the application of neural networks to tabular data.

### BACKGROUND

Tabular data is ubiquitous in both scientific and industrial applications. As deep learning has achieved impressive performance in handling image, language, and audio data, researchers have become increasingly interested in adapting these methods to tabular data. The term “tabular data” refers to data that is organized as a table consisting of a plurality of rows each representing an individual record, and a plurality of columns each representing an attribute of one of the records.

Typically, when processing data in tabular settings, data points are described as vectors or rows made up of different features, and different features can have very different distributions and properties. In these contexts, while deep learning can be applied, traditional Gradient Boosted Decision Trees (GBDT) such as XGBoost, LightGBM, and CatBoost continue to be preferred by practitioners (Chen and Guestrin, 2016, Ke et al., 2017 and Prokhorenkova et al., 2018), as highlighted in various surveys and competitions (Kaggle, 2021, Kossen et al., 2021).

Extensive research, as discussed in Grinsztajn et al., 2022, delves into why tree-based models often outperform deep learning models in tabular dataset domain. The study outlines certain factors that deep learning models need to consider in order to effectively handle tabular datasets: they must be resilient to irrelevant features, respecting the original data orientation, and be able to learn complex and more irregular functions.

In particular, real-world tabular datasets generally contain a large number of features, and many of these features are not useful for downstream models or tasks (Cherepanova et al., 2023), as practitioners often construct tabular datasets by listing exhaustive sets of available features (Cherepanova et al., 2023). For deep learning models, training on such a large number of features, including noisy or uninformative ones, can cause overfitting. This again highlights the importance that any deep learning models be robust to non-informative features for good performance (Grinsztajn et al., 2022).

To mitigate this issue, deep learning architectures that include automatic feature selection mechanisms have emerged. One such approach is “LassoNet” as described by Lemhadri et al., 2021 and which is hereby incorporated by reference. LassoNet is an end-to-end feature selection approach that extends the well-known Lasso regression's feature sparsity concept to neural networks.

LassoNet integrates a skip layer that connects input features directly to the output unit. This skip layer uses learned skip layer weights to constrain the weights of the nonlinear layers in a multi-layer perceptron (MLP). The design enables LassoNet to perform feature selection in an end-to-end fashion, making it a promising candidate for efficiently managing tabular data, especially when many features are superfluous and should be disregarded. Ideally, the ability of deep learning models to autonomously select relevant features could significantly enhance their performance on tabular datasets.

However, the original LassoNet has certain drawbacks, which limit the effectiveness of its selection mechanism in practice.

### SUMMARY

Broadly speaking, the present disclosure describes a neural network architecture that incorporates a nonlinear per-feature embedding that transforms raw input into an embedding, on which linear regression (e.g. Lasso regression) is run and which is used to constrain participation of the input within the neural network.

A pre-training method takes advantage of the nonlinear per-feature embedding architecture. The neural network, which can learn more complex nonlinear interactions, is initialized during a pre-training stage in a way that counter-intuitively limits its ability. By limiting the ability of the neural network during pre-training, the magnitudes of the linear regression parameters reflect the feature importance, so that after pre-training, greater magnitudes of the linear regression coefficients represent greater importance of the corresponding feature.

A proximal gradient training method using coordinate descent that sequentially optimizes the feature selection component and the main neural network is also described.

In one aspect, the present disclosure is directed to a computer-implemented method for training a neural network for processing tabular data comprising training a neural network to output a target from the tabular data, and training a skip layer to constrain the neural network, wherein the skip layer governs an extent to which particular features of the tabular data participate in the neural network, which is characterized in that the skip layer is based on a nonlinear per-feature embedding for each feature of the tabular data.

In some embodiments, the neural network and the skip layer are jointly trained. In particular embodiments, the neural network and the skip layer are jointly trained during an initial pre-training stage and a subsequent feature selection training stage. In specific implementations of such embodiments, the feature selection training stage comprises tracking an exponential moving average of each of (a) skip layer weights of the skip layer; and (b) neural network weights of the neural network. The exponential moving average may be incorporated into a hierarchical proximal operator, which may incorporate soft-thresholding.

In some embodiments, the skip layer is incorporated as an input layer of the neural network.

In some embodiments, the skip layer applies individual weights to respective ones of the features of the tabular data. The skip layer may be adapted to exclude selected ones of the features of the tabular data by setting the respective skip layer weights for the selected ones of the features of the tabular data to zero.

In some embodiments, the skip layer is an unweighted binary sentry layer that either includes or excludes elements of the input.

In another aspect, the present disclosure is directed to a computer-implemented method for training a neural network for processing tabular data comprises training a neural network to output a target from the tabular data, training a nonlinear per-feature embedding from the tabular data, and generating, from the nonlinear per-feature embedding, a nonlinear filter that filters input of the tabular data into the neural network.

In some embodiments, the neural network and the embedding are jointly trained. In particular embodiments, the neural network and the embedding are jointly trained during an initial pre-training stage and a subsequent feature selection training stage. In some embodiments, the feature selection training stage comprises tracking an exponential moving average of each of (a) weights of the nonlinear filter and (b) weights of connections in the neural network, and the exponential moving average may be incorporated into a hierarchical proximal operator.

In some embodiments, the nonlinear filter is incorporated as an input layer of the neural network.

In some embodiments, the filter is adapted to apply individual weights to respective elements of the input. The filter may be adapted to exclude selected ones of the elements of the input by applying a weight of zero to those elements.

In some embodiments, the filter is unweighted and binary and is adapted to either include or exclude elements of the input.

In yet another aspect, the present disclosure is directed to a computer-implemented method for processing tabular data. The method comprises maintaining a trained neural network trained to predict a target from the tabular data and maintaining a trained skip layer to constrain the neural network. The skip layer is based on a nonlinear per-feature embedding for each feature of the tabular data, and the skip layer is used to govern an extent to which particular features of the tabular data participate in the neural network.

In some embodiments, the skip layer is incorporated as an input layer of the neural network.

In some embodiments, the skip layer applies individual skip layer weights to respective features of the tabular data. In particular embodiments, the skip layer is adapted to exclude selected ones of the features of the tabular data by setting the respective skip layer weights for the selected ones of the features of the tabular data to zero.

In some embodiments, the skip layer is an unweighted binary sentry layer that either includes or excludes elements of the input.

In a still further aspect, the present disclosure is directed to a computer-implemented method for processing tabular data. The method comprises maintaining a neural network trained to predict a target from the tabular data, maintaining a nonlinear filter, wherein the nonlinear filter is generated from a nonlinear per-feature embedding trained on the tabular data, and using the nonlinear filter to filter input of the tabular data into the neural network.

In some embodiments, the nonlinear filter is incorporated as an input layer of the neural network.

In some embodiments, the filter is adapted to apply individual weights to respective elements of the input. In particular embodiments, the filter is adapted to exclude selected ones of the elements of the input by applying a weight of zero to those elements.

In some embodiments, the filter is unweighted and binary and is adapted to either include or exclude elements of the input.

In other aspects, the present disclosure is directed to a data processing system comprising at least one processor and memory coupled to the processor(s), wherein the memory contains instructions which, when executed by the processor(s), cause the data processing system to implement any of the above-described methods.

In still further aspects, the present disclosure is directed to at least one tangible, non-transitory computer-readable medium embodying instructions which, when executed by at least one processor of a data processing system, cause the data processing system to implement any of the above-described methods.

### BRIEF DESCRIPTION OF THE DRAWINGS

These and other features will become more apparent from the following description in which reference is made to the appended drawings wherein:

FIG. 1 shows a schematic representation of an illustrative architecture according to an aspect of the present disclosure, including a nonlinear per-feature embedding module, a skip module and a main module;

FIG. 2 shows an illustrative architecture for the main module of FIG. 1, according to an aspect of the present disclosure;

FIG. 3 shows average training loss and average validation loss, with averaged results of 10 runs with different seeds, for a first experiment using a conventional LassoNet implementation;

FIG. 4 shows evolution of skip layer weights, with averaged results of 10 runs with different seeds, for the experiment of FIG. 3;

FIG. 5 shows average training loss and average validation loss, with averaged results of 10 runs with different seeds, for a second experiment using a modified LassoNet implementation;

FIG. 6 shows evolution of skip layer weights, with averaged results of 10 runs with different seeds, for the experiment of FIG. 5;

FIG. 7A shows evolution of skip layer weights over Hier-Prox iterations for a third experiment using a conventional LassoNet implementation;

FIG. 7B shows evolution of first hidden layer weights over Hier-Prox iterations for the experiment of FIG. 7A;

FIG. 8A shows evolution of skip layer weights over iterations of a coordinate descent proximal gradient algorithm for a fourth experiment using a conventional LassoNet implementation;

FIG. 8B shows evolution of first hidden layer weights over iterations of the coordinate descent proximal gradient algorithm for the experiment of FIG. 8A;

FIG. 9 is a flow chart showing an overview of a first illustrative method for training a neural network for processing tabular data, according to an aspect of the present disclosure;

FIG. 9A is a schematic illustration of a first illustrative method for processing tabular data, according to an aspect of the present disclosure;

FIG. 10 is a flow chart showing an overview of a second illustrative method for training a neural network for processing tabular data, according to another aspect of the present disclosure;

FIG. 10A is a schematic illustration of a second illustrative method for processing tabular data, according to an aspect of the present disclosure; and

FIG. 11 is an illustrative computer system in respect of which aspects of the present technology may be implemented.

### DETAILED DESCRIPTION

The present disclosure describes an architecture in which a skip layer that constrains participation of features in a neural network is based on a nonlinear per-feature embedding for each feature of the tabular data, rather than the skip layer being based on linear correlations. The present disclosure also describes a hierarchical proximal gradient using coordinate descent, which inhibits large jumps of learned feature importance (skip layer weights). As a result, the learned skip layer weights can be more effectively used as feature importance to constrain subsequent feature participation in the neural network. The architecture can be used for numerical prediction and classification applications.

Tabular datasets, structured in rows and columns featuring diverse attributes that are usually numerical or categorical, represent one of the earliest and most common types of data used in machine learning in practice (Borisov et al., 2021, Shwartz-Ziv and Armon, 2022). The appeal of using deep learning for tabular data, apart from potential for achieving better performance, extends to its capability to integrate into multi-modal systems, where part of the data might be tabular and other parts could include images, audio, or other data types conducive to deep learning, and the deep learning model can be optimized across all modalities using gradient optimization (Gorishniy et al., 2021). However, tabular data pose certain challenges for deep learning models. For instance, deep learning architectures are often designed with inductive biases that align with the invariances and spatial dependencies observed in the data. However, identifying these invariances in tabular data, which often consists of heterogeneous features, small sample sizes, and extreme values, proves challenging (Grinsztajn et al., 2022).

These benefits as well as challenges have spurred the development of numerous deep learning approaches for tabular data, including innovative models like differentiable trees (Hazimeh et al., 2020, Popov et al., 2020) and attention-based deep tabular models (Arik and Pfister, 2020, Huang et al., 2020a, Gorishniy et al., 2021 and Huang et al., 2020b). Apart from specific model architecture designs, techniques related to tabular data feature embedding are developed in Gorishniy et al., 2022, and the authors empirically show that the proposed embeddings are beneficial for applying deep learning models on tabular data.

LassoNet (Lemhadri et al., 2021) is an end-to-end feature selection approach extending the Lasso regression's feature sparsity concept to neural networks. It employs a unique architecture including a skip-layer (residual connection) connecting input features to output units. Additionally, a hierarchical penalty mechanism regulates feature participation across the network. This setup allows for global feature selection by enforcing that a feature can have non-zero weights in the neural network's hidden units only if it has a non-zero skip-layer weight. The formulation of LassoNet modifies the conventional neural network training objective by incorporating an l₁ penalty on the skip-layer weights and a constraint that links these weights to the first hidden layer, thereby promoting sparsity and feature selection directly during the learning process.

The model architecture of LassoNet is given as:

$$\hat{y} = θ \cdot x + {NN}_{W} ( x ) \qquad ( 1 )$$

where θ is the skip-connection or residual connection weights, and is used to constrain the magnitude of the first hidden layer in NN_{W}, denoted as

$${W}_{j}^{( 1 )} .$$

The mathematical expression of the LassoNet model can be described as follows:

$${min}_{θ , W} L ( θ , W ) + λ {‖ θ ‖}_{1} subject to {‖ {W}_{j}^{( 1 )} ‖}_{∞} \leq M \vert {θ}_{j} \vert , {∀}_{j} \qquad ( 2 )$$

where L(θ, W) is the loss function, for example Mean Squared Loss for a regression problem, θ represents the weights of the skip-layer and each skip layer weight is associated with one input feature, W⁽¹⁾ are the weights of the first hidden layer, λ is the regularization parameter enhancing sparsity, and M is a hyperparameter balancing the influence of the linear (skip layer) and nonlinear (neural network) model components. Learned skip layer weights θ are treated as feature importance, and used to constrain participation of each feature in subsequent computations: if one skip layer weight has a small value, then the weights in W⁽¹⁾ corresponding to that input feature should also be very small, and as W⁽¹⁾ is the first hidden layer, the participation of that feature is thus limited or eliminated.

The optimization of LassoNet involves a proximal gradient method tailored for handling the constraints in Equation (2). This results in an algorithm that alternates between standard gradient descent updates and applying a hierarchical proximal operator specifically designed to respect the skip-layer architecture. This operator, referred to as Hier-Prox, efficiently manages the model's complexity by adjusting the network's capacity to focus on relevant features selectively. The detailed training algorithm for LassoNet is given in Algorithm 1 below.

Algorithm 1 Update Algorithm for LassoNet

| | |
|---|---|
| 1: | Input: training dataset X ϵ [symbol] ^{n×d}, training labels Y, feed-forward |
| | neural network g_{w}(·), number of epochs B, hierarchy multiplier M, |
| | path multiplier ε, learning rate α |
| 2: | Initialize and train the feed-forward network on the loss L(θ, W) |
| 3: | Initialize the penalty, λ = λ₀, and the number of active features, k = d |
| 4: | while k > 0 do |
| 5: | Update λ ← (1 + ε)λ |
| 6: | for b = 1 to B do |
| 7: | Compute gradient of the loss w.r.t to (θ, W) using back-propagation |
| 8: | Update θ ← θ − α∇₅L and W ← W − α∇_{w}L |
| 9: | Update (θ, W⁽¹⁾) ← Hier-Prox(θ, W⁽¹⁾, αλ, M) |
| 10: | end for |
| 11: | Update k to be the number of non-zero coordinates of θ |
| 12: | end while |

The training of LassoNet model consists of two consecutive stages: a pre-training stage and a lambda-training stage. During the pre-training stage, the model is trained purely on the mean squared error (MSE) loss. During the lambda-training stage, a sequence of lambda values are used, which resembles the sequence of penalty strengths in Lasso regression that increasingly sparsify the model. For each lambda value, the hierarchical proximal gradient is applied as shown in Algorithm 1 above. This training strategy is described as a dense-to-sparse warm start approach in the original LassoNet paper.

Conventional LassoNet introduced a framework for incorporating end-to-end feature selection into neural network training: using skip layer weights that connect input features directly to the output unit so that these skip layer weights can pick up correlations between input features and the target during training. Then the magnitude of the skip layer weights for each feature is treated as representing feature importance, and is used to constrain the corresponding feature's participation in the subsequent neural network. The pre-training stage trains the model only with empirical errors (e.g. MSE for a regression task), while the lambda-training stage takes the feature participation constraint in Equation (2) into account: the proximal gradient update is being used to ensure constraint satisfaction after each empirical error gradient update.

Conventional LassoNet uses only linear correlations between input features and targets as indicative of feature importance, that is, linear feature importance, and uses that linear feature importance to dictate whether or not particular features should participate in subsequent nonlinear computations in the MLP. The skip connections, which are linear weights, are much weaker learners compared to the subsequent nonlinear part of the neural network, such as an MLP. Moreover, because these linear skip layer weights are trained at the same time as the nonlinear part of the neural network, the skip layer weights learned during end-to-end training may not accurately reflect feature importance. In addition, the proximal gradient algorithm proposed in conventional LassoNet leads to training instabilities, reflected as large jumps in learned skip layer weights, which can render the skip layer weights less relevant when used as representations of feature importance for constraining feature participation.

In order for the end-to-end feature selection mechanism in Conventional LassoNet to work, before using the skip layer weights to constrain the feature participation in the lambda-training, the pre-training stage should first learn skip layer weights that accurately reflect correlations between input features and the target, otherwise it is not reasonable to use them to constrain subsequent feature participation within the model. This hypothesis was tested by conducting a targeted experiment using the conventional LassoNet approach. An artificial dataset with ground truth linear features was constructed as follows:

$$y = {θ}_{*} \cdot x + α * {NN}_{R} ( x ) + β * noise \qquad ( 3 )$$

where θ_{*} represents the ground truth linear correlations. Only a few elements in θ_{*} are relatively large while the remaining elements are either close to 0 or are 0. NN_{R} is a fixed randomized neural network used to add nonlinearity to the data, and the noise is sampled from a Gaussian distribution with mean 0 and standard deviation 1. The α and β values are used to control the strength of the noise and nonlinearity and were sampled randomly between 0 and 1 for this experiment. Among the three parts that comprise the target y, the linear term dominates.

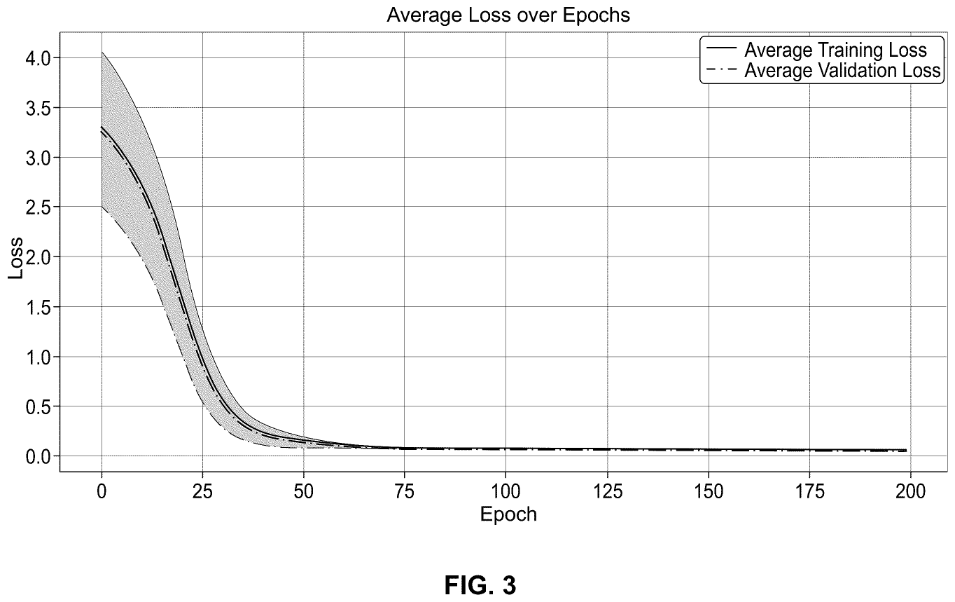

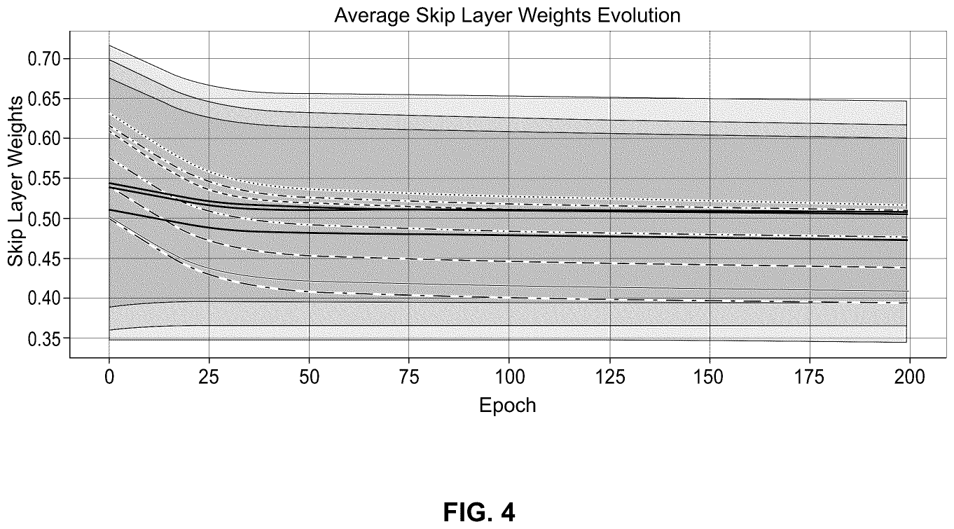

In order for the conventional LassoNet approach to work well, it should be able to pick up, at least approximately, θ_{*} with its skip layer weights during the pre-training stage, then the subsequent lambda-training for using skip layer weights to constrain feature participation will make sense. A conventional LassoNet model was trained with the constructed artificial dataset with strong linear signals, and the training loss, validation loss and evolution of the skip layer weights with respect to training epochs was visualized. FIG. 3 shows the average training loss and average validation loss, and FIG. 4 shows evolution of the skip layer weights, with averaged results of 10 runs with different seeds. For each seed, β, α and NN weights are initialized differently, except that the ground truth θ_{*} and initial skip layer weights in the model are held constant.

From the skip layer weights evolution plot in FIG. 4, it can be observed that the conventional LassoNet approach fails to pick up the strong ground truth linear weights (shown with thick, solid black lines toward the center of the graph), as these important features (according to ground truth θ_{*}) are intermingled with unimportant features (shown with dashed lines).

These training dynamics of conventional LassoNet diminish the significance of using skip layer weights to constrain the feature participation: if skip layer weights for important features are not well-separated from those for unimportant features, this undermines the purpose of the end-to-end feature selection.

Without being limited by theory, it is hypothesized that because the linear part of the conventional LassoNet model, represented by θ·x, is a much weaker learner compared to the subsequent nonlinear part, denoted as NN_{W}. Therefore, during training, the linear part is dominated by the nonlinear part and fails to effectively capture the ground truth linear signal.

In other words, the strong learning capability of the nonlinear components overshadows the linear components, leading to a situation where the skip layer weights, which are crucial for feature selection, are not properly learned. Due to the domination of the nonlinear components over the linear components in conventional LassoNet, the loss can still be minimized even when the skip layer weights do not adequately distinguish and prioritize the important features. If the pre-training stage (with only an empirical loss gradient update as in the above experiment) does not result in skip layer weights that distinguish important features, then any end-to-end feature selection attempt in the lambda-training stage with proximal gradient updates becomes unreasonable. Consequently, the so-called end-to-end feature selection of the conventional LassoNet architecture becomes ineffective.

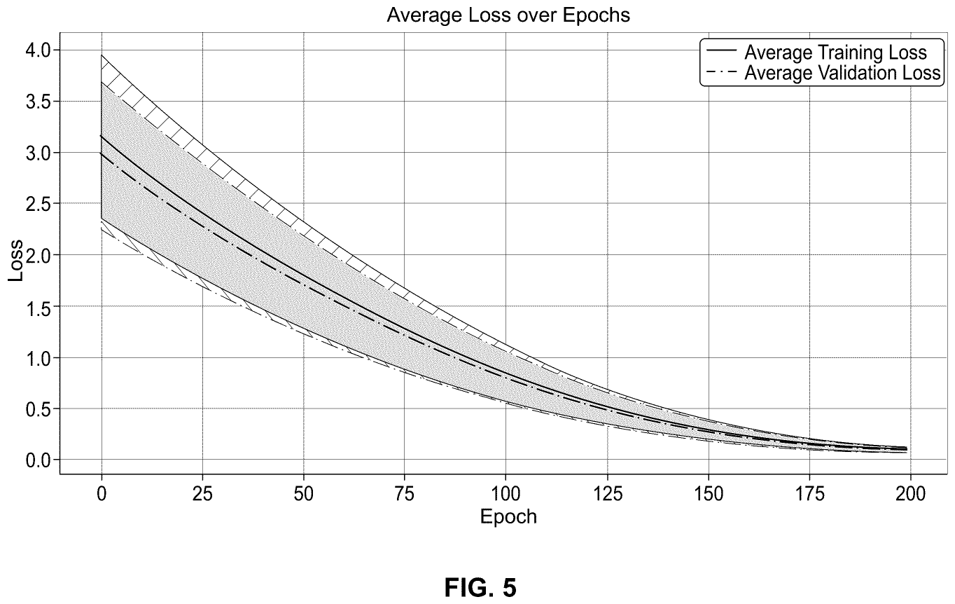

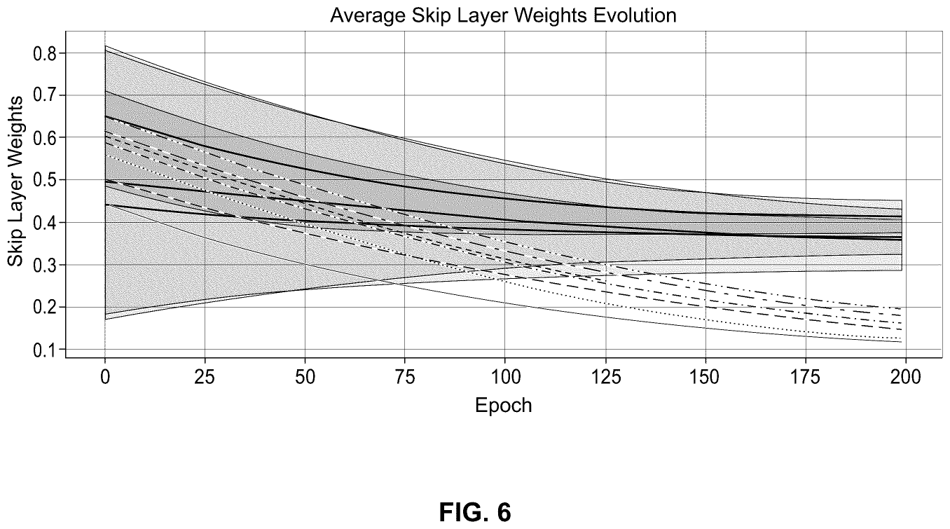

The foregoing hypothesis is further validated by slightly changing the conventional LassoNet model: the original conventional model is ŷ=θ*x+MLP(x), and is modified by multiplying a small scalar term τ at the front of MLP so that ŷ=θ*x+τ*MLP(x). With this modification, there is greater emphasis on learning of the skip layer weights during training, and the same plots as shown in FIG. 3 (average training loss and average validation loss) and FIG. 4 (evolution of the skip layer weights) are shown in FIG. 5 and FIG. 6, respectively, for the modification ŷ=θ*x+τ*MLP(x) where τ=0.001. As can be seen in FIG. 6, there is significant separation between the strong ground truth linear weights (shown with thick, solid black lines toward the center of the graph) and the unimportant features (shown with dashed lines and trending toward the bottom of the graph).

As illustrated, using a scalar to repress the nonlinear part of the model can result in the skip layer weights better recovering the ground truth linear relations within the data. As can be seen in FIG. 5, the training and validation losses decrease at a slower pace with τ=0.001 than without τ present (FIG. 3), which further validates the hypothesis that for conventional LassoNet, the nonlinear part dominates the training results resulting in a faster decrease in loss, but at the cost of ineffective learning of skip layer weights.

Thus, without being limited by theory, it is believed that an inherent weakness of the conventional LassoNet approach is that due to the expressiveness of the nonlinear part of the model, the loss can be minimized without learning good skip layer weights, which undermines the purpose of having the skip layer weights in the first place.

When using a skip layer to constrain a neural network, for the skip layer weights learning to be effective, the skip layer should have similar expressive power to the neural network component (which is being constrained by the skip layer) so that the skip layer can learn the feature importance well and then be used to constrain feature participation. As demonstrated above, adding a small scalar value τ will accomplish this for some simple datasets. However, a more general approach is adding learnable nonlinear layers that transform each feature into its nonlinear embedding vector, and then connecting each embedding vector to target y using a respective skip layer weight, which significantly improves the expressiveness of the skip layer. Therefore, the skip layer can be better trained and capture feature importance during the pre-training stage before being used to constrain feature participation in feature selection training stage.

As noted above, the present disclosure describes an architecture in which a skip layer that constrains participation of features in a neural network is based on a nonlinear per-feature embedding for each feature of the tabular data. In this architecture, the scalar value t may be retained, and treated as a hyper-parameter.

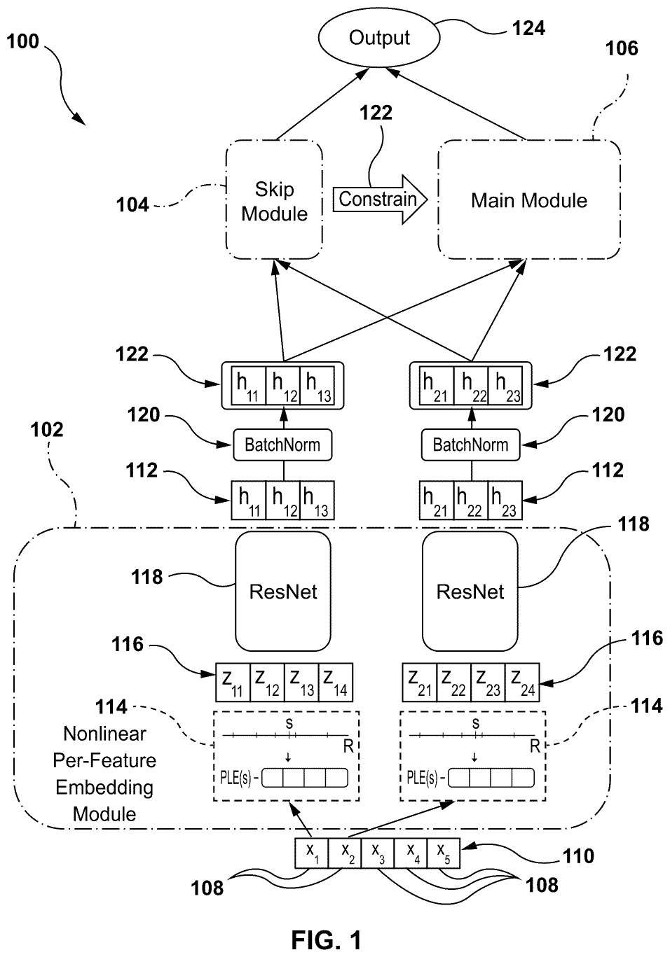

Referring now to FIG. 1, in one embodiment, an architecture 100 according to an aspect of the present disclosure comprises a nonlinear per-feature embedding module 102, a skip module 104 that implements a skip layer, and a main module 106 that implements a neural network. The skip module 104 comprises residual connections that connect each nonlinearly embedded feature to the output (or per-activation for softmax in classification applications), and the main module 106 is constrained by the skip layer weights of the skip module 104. More precisely, in an illustrative embodiment the architecture 100 is described by the following equations:

$$\hat{y} = θ \cdot z + τ \cdot {NN}_{w} ( z ) \qquad ( 4 )$$

$$z = {NN}_{ϕ} ( x ) \qquad ( 5 )$$

where τ is a non-learnable constant smaller than 1. Each of θ, ϕ and W are learnable parameters which parameterize the linear skip connections part θ, the per feature embedding NN_{ϕ}, as well as the residual neural net NN_{W}.

The per-feature embedding module 102 takes each raw feature 108 (x₁, x₂, . . . x₅) from the tabular datasets 110, and returns a high dimensional nonlinear embedding 112 for each individual feature. Within the per-feature embedding module 102, a piece-wise linear encoding (PLE) operation 114, for example as proposed in Gorishniy et al., 2022 and incorporated herein by reference, may be applied for numerical features and one-hot encoding may be applied for categorical features. The use of PLE for numerical features is to impose uniformity on widely ranging inputs (e.g. fat tail distributions found in tabular data) by sorting them into different quantiles. Well-ranged inputs typically lead to more stable training dynamics for deep learning models. The PLE encoding operation 114 transforms each raw feature 108 into an embedding vector 116 shown as z_{i,j} in FIG. 1, where i is the feature index and j is the embedding index, and this embedding vector 116 is fed as input to a ResNet architecture 118 to further uncover nonlinear relations between this feature i and the target y, as the embedding vector 112 resulting from transformation by the ResNet architecture 118 is connected to the target y with skip connections in the subsequent skip module 104. The output of the per-feature embedding module 102 is a set of embedding vectors 112 associated with each feature 108 individually. ResNet parameters are preferably not shared among features, as features may have a very different distribution and properties in tabular datasets. This preserves the one-to-one correspondence between each raw input feature 108 and each embedding vector 112.

Before the embedding vectors 112 coming out of the per-feature embedding module 102 are passed into the skip module 104, the embedding vectors 112 are normalized via batch normalization 120 to obtain normalized embedding vectors 122, analogously to standardization of features as applied in Lasso linear regression. Within the skip module 104, in order to associate each normalized embedding vector 122, and thus each input feature 108, with one skip layer weight, the skip layer weight is used to connect the mean of each normalized embedding vector 122 to the target y. The skip module 104 constrains 122 the main module 106, which generates the output 124, i.e. a prediction or classification, for example. The skip module 104 may also participate in generating the output 124 pursuant to equation (4). With this combination of skip connection and the nonlinear per-feature embedding module 102, the architecture 100 departs from the linear assumption in conventional LassoNet. In conventional LassoNet, if a feature is not linearly correlated with the target, that feature will not participate significantly in the subsequent neural network computations. In the illustrative architecture 100, if the high dimensional embedding of a feature is not linearly correlated with the target, that feature will not participate significantly in the subsequent neural network computations by the main module 106. Of note, the linear correlations here already consider the feature interactions in the linear regression sense; in linear regression the analytical solution is θ*=(z^{T}z)⁻¹z^{T}y where θ already considers the feature interactions term, since z^{T}z is the feature embedding covariance matrix, and z^{T}y is the feature embedding-target covariance vector (this is merely a heuristic as the analytical form only applies for regular linear regression, but it serves as a reasonable approximation).

Now that they are connected to the normalized embedding vector 122 of each input feature 108 instead of the input feature 108 itself, the skip connections can potentially capture more complex relations between input features 108 and the targets, so these skip connections are more representative than with linear correlations. The skip connections can be treated as representative of feature importance for constraining subsequent feature participation.

FIG. 1 is merely an illustrative embodiment, and is not limiting.

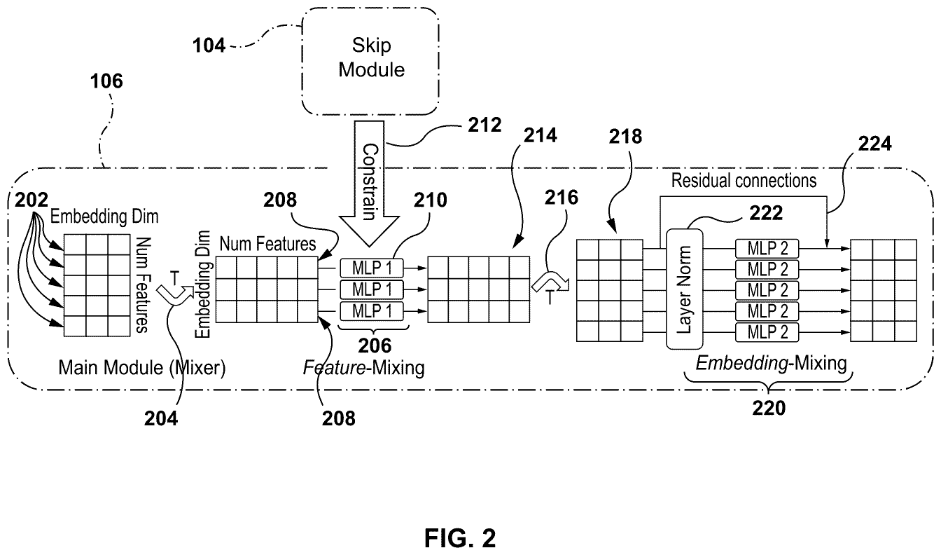

FIG. 2 shows an illustrative architecture for the main module 106. The main module 106 utilizes a MLP Mixer architecture as described in Tolstikhin et al., 2021, which is incorporated herein by reference, and the architecture shown in FIG. 2 is similar to the Mixer block. The reason for choosing a Mixer architecture is that the mixing operations in Mixer allows for natural incorporation of skip layer weights to constrain feature participation. The use of a MLP Mixer architecture is merely one illustrative embodiment, and is not limiting. Other suitable architectures may also be used.

The input to the main module 106 will be the normalized embedding vectors 122 (FIG. 1) for all features 108 (FIG. 1), and each row 202 is a feature embedding vector. A first transpose operation 204 is performed. After the first transpose operation 204, the feature mixing 206 operates at each embedding dimension (each row 208 of the transposed input), and the same MLP1 210 is used to mix the feature values at all feature dimensions. Therefore, there is good correspondence between the skip layer weights from the skip module 104, which constrain 212 feature participation, and the hidden layer weights in MLP1 210. By way of non-limiting example, if there are 8 input features, then there would be 8 skip layer weights, and 8*64 hidden weights W₁ in the first hidden layer of MLP1 210 if the hidden layer size is 64. Thus the constraints in Equation (2):

$${‖ {W}_{j}^{( 1 )} ‖}_{∞} \leq M \vert {θ}_{j} \vert , {∀}_{j}$$

can be applied for all features (∀ⱼ). Of note, the feature mixing 206 operating at each embedding dimension (each row 208) omits any LayerNorm or residual connections to ensure that the feature mixing is the only pathway of the feature embedding vector, so that the skip layer weights constraint 212 is effective in controlling feature participation. The result 214 of the feature mixing 206 is then subjected to a second transpose operation 216, the result 218 of which is then subject to one or more applications of embedding mixing 220, which preferably include LayerNorm 222 and residual connections 224 and may be implemented using a MLP Mixer architecture. Only a single application of embedding mixing 220 is shown for purposes of illustration, in practice multiple applications of embedding mixing 220 are used.

The MLP Mixer design stacks multiple Mixer blocks. Each block can be written as follows (omitting layer indices):

$${U}_{* , i} = {X}_{* , i} + {W}_{2} σ ( {W}_{1} {LayerNorm ( X )}_{* , i} ) , for i = 1 ... C ,$$

$${Y}_{j , *} = {U}_{j , *} + {W}_{4} σ ( {W}_{3} {LayerNorm ( U )}_{j , *} ) , for j = 1 ... T .$$

where C, T are positive integers standing for number of channels and number of tokens. The above equation takes input X and outputs Y: B(X)=Y. Such operation is refereed to as a “mixer block”. The MLP Mixer stacks L such blocks:

$$Y = B ∘ … ∘ B ( X ) \qquad ( 6 )$$

Two modifications may be made to the MLP Mixer, motivated by the work of Zhang et al. (2022).

The first modification is as follows:

$${U}_{* , i} = {X}_{* , i} + τ {W}_{2} σ ( {W}_{1} {LayerNorm ( X )}_{* , i} ) , \qquad for i = 1 … C ,$$

$${Y}_{j , *} = {U}_{j , *} + τ {W}_{4} σ ( {W}_{3} {LayerNorm ( U )}_{j , *} ) , \qquad for j = 1 … T .$$

where τ is a non-learnable small constant, typically in the range of 0.01 to 1 (although not necessarily limited to that range).

The second modification is on the block stacking. The original block operator B is extended to be B_{τ}:

$$Y = {B}_{τ} ( X ) = X + τ B ( X ) \qquad ( 7 )$$

where τ is again a non-learnable small constant, typically in the range of 0.01 to 1 (although not necessarily limited to that range).

The proximal gradient is the optimization used in parallel with the empirical loss gradient update during feature selection training to ensure that constraints between the skip layer weights θ and the weights W⁽¹⁾ of the first hidden layer are satisfied. More specifically, once the pre-training is completed, and the skip layer weights θ can capture the feature importance well, the proximal gradient then uses the well-trained skip layer weights θ to constrain the weights W⁽¹⁾ of the first hidden layer, so that unimportant features do not participate in subsequent computations in the network.

Since the skip layer weights θ capture the feature importance after the pre-training stage, in order for the proximal gradient algorithm to be effective in feature selection during feature selection training, the skip layer weights θ should not be heavily influenced by the weights W⁽¹⁾ of the first hidden layer during proximal gradient update, but rather the weights W⁽¹⁾ of the first hidden layer should be sparsified according to the skip layer weights θ to reflect feature importance.

The present disclosure describes a proximal gradient optimization that optimizes the skip layer weights θ and the weights W⁽¹⁾ of the first hidden layer according to a two-stage process. This is distinguished from the proximal gradient optimization in conventional LassoNet, which optimizes the skip layer weights θ and the weights W⁽¹⁾ of the first hidden layer concurrently. The concurrent optimization in conventional LassoNet results in large jumps in the skip layer weights θ under the influence of the weights W⁽¹⁾ of the first hidden layer due to size asymmetry between the skip layer weights θ and the weights W⁽¹⁾ of the first hidden layer.

The proximal gradient algorithm in the conventional LassoNet approach is denoted as Hier-Prox. To be consistent with the original LassoNet paper, the skip layer weights θ are denoted as b and the weights W⁽¹⁾ of the first hidden layer are denoted as W. Hier-Prox returns the global optimum of the following optimization problem:

$${minimize}_{b ∈ ℝ , W ∈ {ℝ}^{K}} \frac{1}{2} {( v - b )}^{2} + \frac{1}{2} {‖ u - W ‖}_{2}^{2} + λ \vert b \vert ,$$

$$subject to$$

$${‖ W ‖}_{∞} \leq M \vert b \vert$$

where v∈ [symbol] is a scalar and u∈ [symbol] ^{K} is a vector. When a group of θ is used to constrain the hidden layer weights, HIER-Prox-Group can be used, and it returns the global optimum of the following problem:

$${minimize}_{( b , W )} \frac{1}{2} ( {‖ v - b ‖}_{2}^{2} + {‖ U - W ‖}_{2}^{2} ) + λ {‖ b ‖}_{2} ,$$

$$subject to$$

$${‖ W ‖}_{∞} \leq M {‖ b ‖}_{2}$$

where v∈ [symbol] ^{K}, U∈ [symbol] ^{K} are vectors of the same size.

It turns out that the aforementioned two results are special cases of the following proposition. They can be easily recovered by setting λ̅=0. There is a common optimization problem: fix v∈ [symbol] ^{k} and U∈ [symbol] ^{K}. The two integers k, K can be different. Consider the problem:

$${minimize}_{b , W} \frac{1}{2} ( {‖ v - b ‖}_{2}^{2} + {‖ U - W ‖}_{2}^{2} ) + λ {‖ b ‖}_{2} + \overline{λ} {‖ W ‖}_{1}$$

$$subject to$$

$${‖ W ‖}_{∞} \leq M \cdot {‖ b ‖}_{2}$$

As noted above, a weakness of the Hier-Prox algorithm in conventional LassoNet arises from the asymmetric sizes of b and W: in practice, there are many more parameters in W than in b with the result that the joint optimization problem will skew towards W. This can be seen in the above derivation, where the optimal W(b) dependence is found first, and then the optimization is solved in terms of b. However, this b now needs to consider the many W(b), with problems arising from self-dependency.

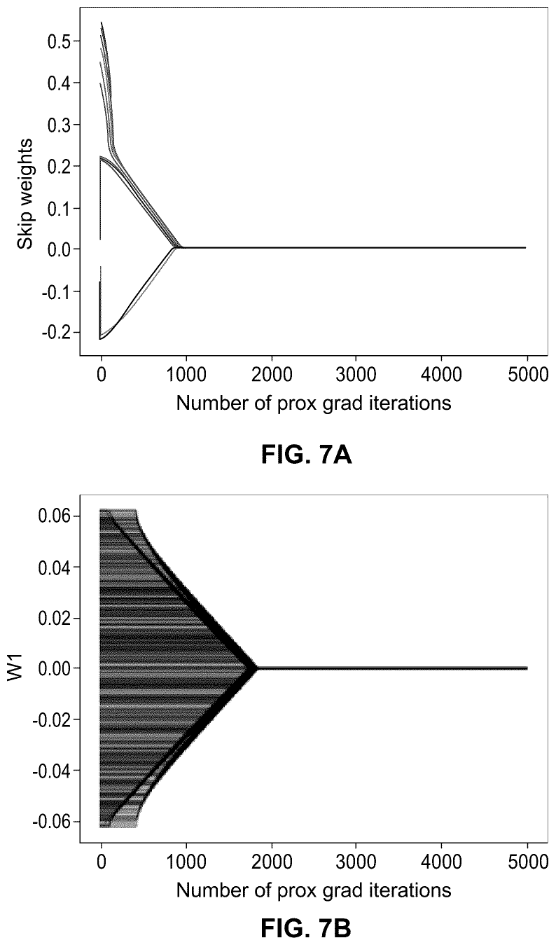

This weakness of the Hier-Prox algorithm in conventional LassoNet can be demonstrated experimentally using, as an illustrative example, a pre-trained conventional LassoNet model for the California Housing dataset with added random noise, which is a benchmark dataset used in Cherepanova et al., 2023. The conventional Hier-Prox algorithm can be executed repeatedly on the model's current skip layer weights and first hidden layer weights, and the evolution of these weights as the number of Hier-Prox algorithm iterations increases can be observed and plotted. In this experiment, the default values in the LassoNet repository located at https://github.com/lasso-net/lassonet and incorporated herein by reference were used for hyper-parameters in lambda-training (M=5). FIG. 7A shows evolution of the skip layer weights and FIG. 7B shows evolution of the hidden layer weights.

Before any Hier-Prox update has occurred (at iteration 0), the skip layer weights are well separated, which reflects that the pre-training stage has successfully identified important features and discarded the added noise. However, once the proximal gradient update starts, a single Hier-Prox update of the skip layer weights and first hidden layer weights results in abrupt changes in the skip layer weights. As a result, for all subsequent updates, the first hidden layer weights (W⁽¹⁾) are penalized in a similar manner and do not show a sparse pattern, because the skip layer weights (θ in the right hand side of constraint in Equation (2) above) now have values that are not significantly related to feature importance because of the abrupt changes to the jump. In a sense, the feature importance learned during the pre-training stage is wasted.

To inhibit sudden changes in value for the skip layer weights, a two-stage proximal gradient based on coordinate descent may be used during the feature selection training, where the optimality for b is solved first via the following optimization:

$${minimize}_{b} \frac{1}{2} ( ‖ v - b {‖}_{2}^{2} ) + λ {‖ b ‖}_{1}$$

Then one may solve for optimal W depending on optimal b:

$${minimize}_{W} \frac{1}{2} ( {‖ U - W ‖}_{2}^{2} + \overline{λ} {‖ W ‖}_{1}$$

$$subject to$$

$${‖ W ‖}_{∞} \leq M \cdot {‖ b ‖}_{2}$$

The results of the above optimizations are as follows. The optimal b is given by:

$$Soft - Thresholding Operator : {\tilde{v}}^{( 1 )} = {S}_{λ} ( v ) \qquad ( 8 )$$

$${argmin}_{b} \frac{1}{2} ( {‖ v - b ‖}_{2}^{2} ) + λ {‖ b ‖}_{1} = {S}_{λ} ( v ) \qquad ( 9 )$$

$${[ {S}_{λ} ( v ) ]}_{i} = \{ \begin{matrix}{v}_{i} - λ & if {v}_{i} > λ \\ 0 & if - λ \leq {v}_{i} \leq λ , i = 1 , … , n \\ {v}_{i} + λ & if {v}_{i} < - λ\end{matrix} \qquad ( 10 )$$

where S_{λ}(v) is the soft-thresholding operator and [Sᵥ(v)]ᵢ is the coordinate point-wise evaluation of S_{λ}(v).

The optimal W is given by the following algorithm:

Algorithm 2 Hierarchical Proximal Operator for Finding Optimal W

| | |
|---|---|
| 1: | \tilde{W}⁽¹⁾ = (θ, W⁽¹⁾; λ, M) |
| 2: | for ƒ = 1 to d do |
| 3: | Sort the entries of ${W}_{j}^{( 1 )} into \vert {W}_{( j , 1 )}^{( 1 )} \vert \geq … \geq \vert {W}_{( j , K )}^{( 1 )} \vert$ |
| 4: | for m = 0 to K do |
| 5: | $Compute {w}_{m} := \frac{M}{1 + {mM}^{2}} \cdot {S}_{λ} ( \vert {θ}_{j} \vert + M \cdot {\sum }_{i = 1}^{m} \vert {W}_{( j , i )}^{( 1 )} \vert$ |
| 6: | end for |
| 7: | Find \tilde{m}, the first m such that $\vert {W}_{( j , m + 1 )}^{( 1 )} \vert \leq {w}_{m} \leq \vert {W}_{( j , m )}^{( 1 )} \vert$ |
| 8: | ${\tilde{W}}_{j}^{( 1 )} ← sign ( {W}_{j}^{( 1 )} ) \cdot min ( {w}_{\tilde{m}} \vert {W}_{j}^{( 1 )} \vert )$ |
| 9: | end for |
| 10: | return \tilde{W}⁽¹⁾ |
| 11: | end procedure |
| 12: | Notation: d denotes the number of features; |
| | K denotes the size of the first hidden layer. |
| 13: | Conventions: Ln. 6, ${W}_{( j , K + 1 )}^{( 1 )} = 0 , {W}_{( j , 0 )}^{( 1 )} = + ∞ ;$ |
| | Ln. 9, minimum and absolute value are applied coordinate-wise. |

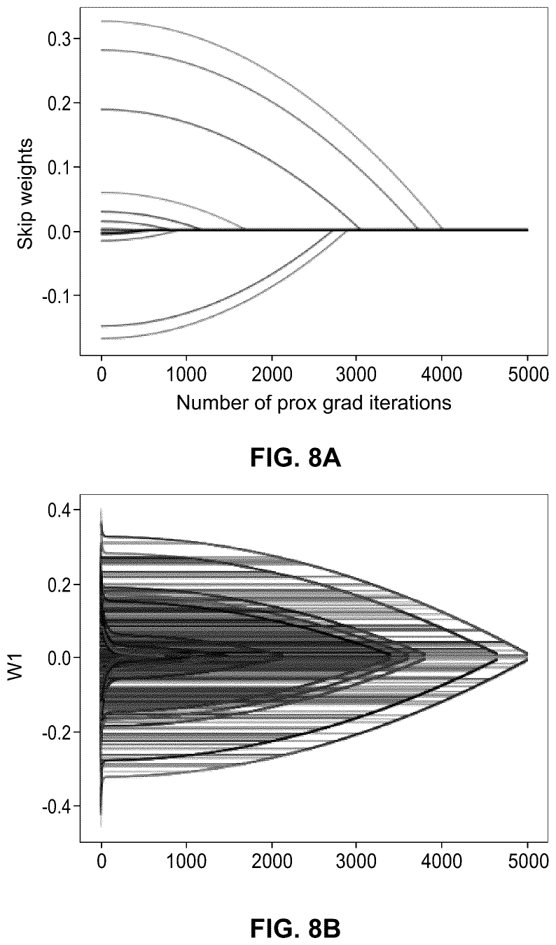

The experiment described above, using a pre-trained conventional LassoNet model for the California Housing dataset with added random noise, was repeated but with the coordinate descent proximal gradient algorithm substituted for the Hier-Prox algorithm from conventional LassoNet. Thus, the experiment begins with pre-trained model skip layer weights and first hidden layer weights, and the coordinate descent proximal gradient algorithm is repeatedly called and the evolution of the skip layer weights and first hidden layer weights can be observed. FIG. 8A shows evolution of the skip layer weights and FIG. 8B shows evolution of the first hidden layer weights. As can be seen in FIG. 8A, evolution of the skip layer weights is much smoother and does not contain any abrupt changes; thus, the feature selection training is using the learned feature importance from the pre-training stage more effectively. As a result, as shown in FIG. 8B the first hidden layer weights evolve to become sparse, which would result in certain features participating in the neural network computations and certain features being filtered out.

Since neither soft-thresholding nor hierarchical proximal gradient operators take stochastic optimization into consideration, the following modification based on tracking exponential moving average (EMA) of the parameters (b, W) may be used:
Soft-Thresholding Operator with EMA v1: \tilde{v}⁽¹⁾=S_{λ}(v,v^{EMA})

$${[ {S}_{λ} ( v , {v}^{EMA} ) ]}_{i} = \{ \begin{matrix}{v}_{i} - λ & if {v}_{i}^{EMA} > λ \\ 0 & if - λ \leq {v}_{i}^{EMA} \leq λ , i = 1 , … , n \\ {v}_{i} + λ & if {v}_{i}^{EMA} < - λ\end{matrix} \qquad ( 11 )$$

or alternatively,
Soft-Thresholding Operator with EMA v2: \tilde{v}⁽¹⁾=S_{λ}(v,v^{EMA})

$${[ {S}_{λ} ( v , {v}^{EMA} ) ]}_{i} = \{ \begin{matrix}{v}_{i}^{EMA} - λ & if {v}_{i}^{EMA} > λ \\ 0 & if - λ \leq {v}_{i}^{EMA} \leq λ , i = 1 , … , n \\ {v}_{i}^{EMA} + λ & if {v}_{i}^{EMA} < - λ\end{matrix} \qquad ( 12 )$$

Soft-Thresholding Operator with EMA v3: \tilde{v}⁽¹⁾=S_{λ}(v,v^{EMA})

$${[ {S}_{λ} ( v , {v}^{EMA} ) ]}_{i} = \{ \begin{matrix}{v}_{i}^{EMA} - λ & if {v}_{i} > λ \\ 0 & if - λ \leq {v}_{i} \leq λ , i = 1 , … , n \\ {v}_{i}^{EMA} + λ & if {v}_{i} < - λ\end{matrix} \qquad ( 13 )$$

A characteristic of the soft thresholding operator is that the magnitude of the skip connection layer, or the absolute value of θ, will decrease over time. In some applications, it may be desirable to provide stronger monotonicity. That is, not only does the absolute value of θ decrease, but it decreases more monotonically under soft thresholding. The following describes illustrative, non-limiting alternative implementations that encourage stronger monotonicity.

In equation (11), instead of choosing to regularize based on sign of v (parameters of the Lasso linear regression), the EMA version of v is used. This design change is motivated by the noise in stochastic optimization, where Sign (v) may be less reliable, so it is replaced by Sign(v^{EMA}). Because the magnitudes of v and v^{EMA} may not decrease monotonically over time, and may not decrease simultaneously, the EMA operator may be used to encourage stronger monotonicity due to the stability of its signs. Thus, equation (11) may be adapted to:
Soft-Thresholding Operator with EMA v1A: \tilde{v}⁽¹⁾=S_{λ}(v,v^{EMA})

$$( 11 A )$$

$${[ {S}_{λ} ( v , {v}^{EMA} ) ]}_{i} = \{ \begin{matrix}max ( \vert {v}_{i} - λ \vert , 0 ) & if {v}_{i}^{EMA} > λ \\ 0 & if - λ \leq {v}_{i}^{EMA} \leq λ , i = 1 , … , n \\ min ( - 1 \cdot ( \vert {v}_{i} + λ \vert , 0 ) ) & if {v}_{i}^{EMA} < - λ\end{matrix}$$

This is referred to as “EMA Sign Modification”. Since vᵢ^{EMA} is more stable than vᵢ, equation (11A) above may exhibit stronger monotonicity than equation (11).

A second modification is similarly motivated but uses the EMA information to control the magnitude. An additional weight magnitude constraint is added by making use of v^{EMA}. For example, if |v^{EMA}| monotonically decreases over time, even if v is large due to optimization dynamics noise, the Lasso sparsification/weight magnitude constraint will remain. Faster learning dynamics have been observed empirically using this approach. This latter approach is referred to as “EMA Magnitude Modification”.
Soft-Thresholding Operator with EMA v4: \tilde{v}=S_{λ}(v,v^{EMA})

$$( 14 )$$

$${[ {S}_{λ} ( v , {v}^{EMA} ) ]}_{i} = \{ \begin{matrix}max ( min ( {v}_{i} , N \cdot \vert {v}_{i}^{ENA} \vert ) , - λ , 0 ) & if {v}_{i} > λ \\ 0 & if - λ \leq {v}_{i} \leq λ , i = 1 , … , n \\ min ( max ( {v}_{i} , - 1 \cdot N \cdot \vert {v}_{i}^{EMA} \vert ) + λ , 0 ) & if {v}_{i} < - λ\end{matrix}$$

where N≥1 can be interpreted as a relaxed constraint constant. In this approach, the min and, max between vᵢ^{EMA} and vᵢ is used to encourage stronger monotonicity.

A third modification combines both EMA Sign Modification and EMA Magnitude Modification:
Soft-Thresholding Operator with EMA v5: \tilde{v}=S_{λ}(v,v^{EMA})

$$( 15 )$$

$${[ {S}_{λ} ( v , {v}^{EMA} ) ]}_{i} = \{ \begin{matrix}max ( min ( {v}_{i} , N \cdot \vert {v}_{i}^{EMA} \vert ) - λ , 0 ) & if {v}_{i}^{EMA} > λ \\ 0 & if - λ \leq {v}_{i}^{EMA} \leq λ , i = 1 , … , n \\ min ( max ( {v}_{i} , - 1 \cdot N \cdot \vert {v}_{i}^{EMA} \vert ) + λ , 0 ) & if {v}_{i}^{EMA} < - λ\end{matrix}$$

where N≥1 can be interpreted as a relaxed constraint constant. This approach may encourage monotonicity more strongly, as it uses both the signs and magnitudes.

Using the same reasoning and techniques described above, modification is made to the second coordinate operator, the Hierarchical Proximal Operator with EMA v1:

```
\tilde{W}⁽¹⁾ = (θ^{EMA}, W⁽¹⁾, W^{EMA;(1)}; λ, M)
for j ∈ {1, . . . , d} do
  Sort the entries of ${W}_{j}^{E M A ; ( 1 )} into \vert {W}_{( j , 1 )}^{E M A ; ( 1 )} \vert \geq … \geq \vert {W}_{( j , K )}^{E M A ; ( 1 )} \vert$
  for m ∈ {0, . . . , K} do
    Compute ${w}_{m} := \frac{M}{1 + m {M}^{2}} \cdot {S}_{λ} ( \vert {θ}_{j}^{E M A} \vert + M \cdot {\sum }_{i - 1}^{m} \vert {W}_{( j , i )}^{E M A ; ( 1 )} \vert ) \qquad ( 16 )$
  end for
  Find \tilde{m}, the first m ∈ {0, . . . , K} such that
  $\vert {W}_{( j , m + 1 )}^{EMA ; ( 1 )} \vert \leq {w}_{m} \leq \vert {W}_{( j , m )}^{EMA ; ( 1 )} \vert {\tilde{W}}_{j}^{( 1 )} ← sign ( {W}_{j}^{EMA ; ( 1 )} ) \cdot min ( {w}_{\tilde{m}} \vert {W}_{j}^{( 1 )} \vert ) \qquad ( 16 v1 )$
end for
return \tilde{W}⁽¹⁾
end procedure
Notation: d denotes the number of features; K denotes the size
of the first hidden layer.
Conventions: Ln. 6, ${W}_{( j , K + 1 )}^{( 1 )} = 0 , {W}_{( j , 0 )}^{( 1 )} = + ∞ ; L n . 9$
minimum and absolute value are applied coordinate-wise.
```

Another embodiment is the Hierarchical Proximal Operator with EMA v2:

\tilde{W}(1) = (θ^{EMA}, W⁽¹⁾, W^{EMA;(1)}; λ, M)
for j ∈ {1, . . . , d} do
${\tilde{W}}_{j}^{( 1 )} ← sign ( {W}_{j}^{EMA ; ( 1 )} ) \cdot min ( M \vert {θ}_{j}^{E M A} \vert , M \vert {θ}_{j} \vert , \vert {W}_{j}^{E M A ; ( 1 )} \vert , \vert {W}_{j}^{( 1 )} \vert ) \qquad ( 16 v2 )$
end for
return \tilde{W}(1)

Other variants, with or without some of the EMA information, can also be implemented. Other Hierarchical Proximal Operators with EMA can be constructed by, for example but without limitation, inserting suitable objects into equation (16 v2).

An example of the Hierarchical Proximal Operator without EMA:

\tilde{W}⁽¹⁾ = (θ, W⁽¹⁾, W⁽¹⁾; λ, M)
for j ∈ {1, . . . , d} do
${\tilde{W}}_{j}^{( 1 )} ← sign ( {W}_{j}^{( 1 )} ) \cdot min ( M \vert {θ}_{j} \vert , \vert {W}_{j}^{( 1 )} \vert ) \qquad ( 17 )$
end for
return \tilde{W}⁽¹⁾

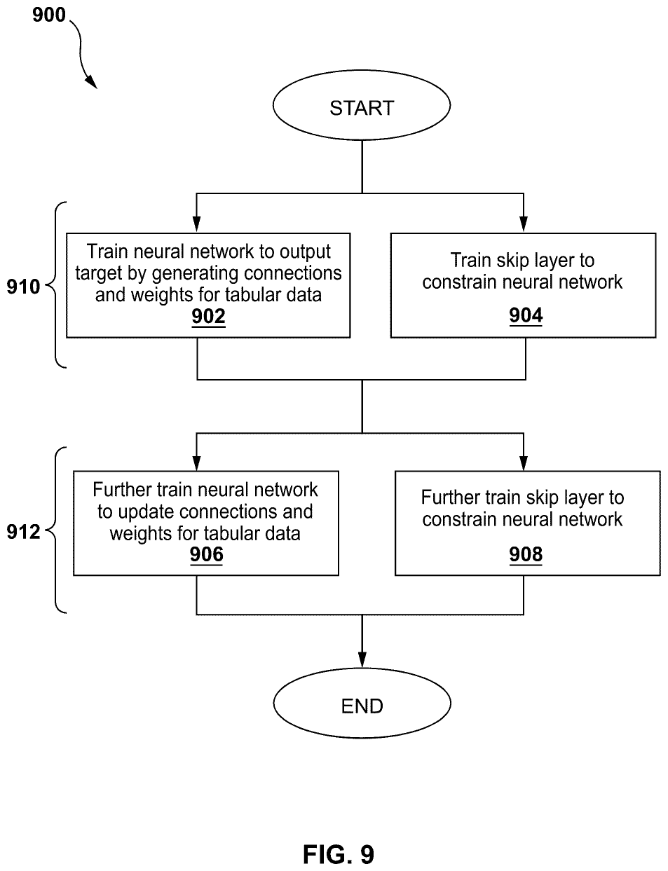

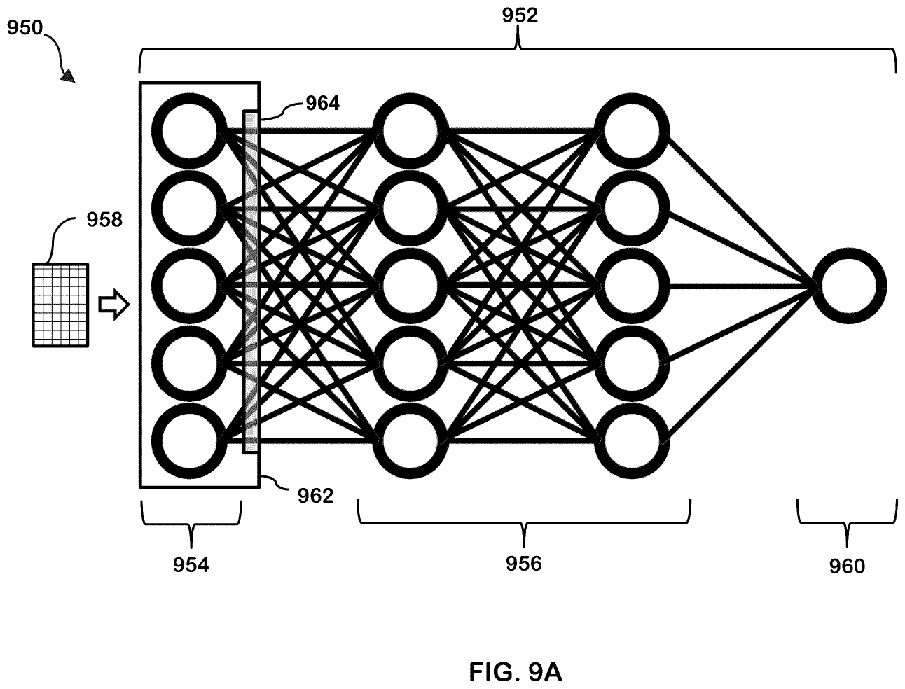

Reference is now made to FIG. 9, which is a flow chart showing an overview of an illustrative method 900 for training a neural network for processing tabular data, as described in more detail above. At step 902, the method 900 trains a neural network to output a target from the tabular data by (e.g.) generating hidden layer connections and hidden layer weights for the tabular data. The target may be, for example, a prediction (e.g. a numerical prediction) or a classification. At step 904, the method 900 trains a skip layer to constrain the neural network. The skip layer governs the extent to which particular features of the tabular data participate in the neural network, and is based on a nonlinear per-feature embedding for each feature of the tabular data instead of being based on linear correlation as in conventional LassoNet. Thus, the skip layer functions as a filter for the input into the neural network and step 904 therefore comprises training a nonlinear per-feature embedding from the tabular data and generating, from that nonlinear per-feature embedding, a nonlinear filter that filters input of the tabular data into the neural network. The method 900 then proceeds to steps 906 and 908. At step 906, the method 900 further trains the neural network to update the connections and weights for the tabular data, and step 908 further trains the skip layer to constrain the neural network, thereby refining the nonlinear filter effected by the skip layer.

As can be seen in FIG. 9, in the illustrated embodiment the neural network and the skip layer are jointly trained and steps 902 and 904 proceed in parallel with one another and steps 906 and 908 also proceed in parallel with one another. More particularly, the neural network and the skip layer are jointly trained during an initial pre-training stage 910 comprising steps 902 and 904, and a subsequent feature selection training stage 912 comprising steps 906 and 908. The feature selection training stage 912 may comprise tracking an exponential moving average of each of (a) skip layer weights of the skip layer; and (b) neural network weights of the neural network (e.g. hidden layer weights). The exponential moving average may be incorporated into a hierarchical proximal operator, which in turn may incorporate soft-thresholding.

With reference now to FIG. 9A, an illustrative computer-implemented method for processing tabular data is shown generally at 950, and may be carried out after the training method 900 described in the context of FIG. 9. The method 950 maintains a trained neural network 952 comprising an input layer 954, a plurality of hidden layers 956 having hidden layer connections and hidden layer weights for the tabular data 958 that is input into the input layer 954, and an output layer 960. The method 950 further maintains a trained skip layer 962 to constrain the neural network 952. The skip layer 962 is based on a nonlinear per-feature embedding for each feature of the tabular data. The method 950 uses the skip layer 962 to govern 964 the extent to which particular features of the tabular data 958 participate in the neural network 952. The skip layer 958 may be incorporated as the input layer 954 of the neural network 952, as shown in FIG. 9A, or may remain a separate layer.

The skip layer preferably applies individual skip layer weights to respective ones of the features of the tabular data, based on the significance of those elements, and may be adapted to exclude selected elements of the input, i.e. those determined to be insignificant, by setting the respective skip layer weights for the selected ones of the features of the tabular data to zero. Additionally or alternatively, the skip layer can apply a skip layer weight that is close to zero to nearly exclude selected elements of the input. By way of non-limiting example, the skip layer weights applied to those elements determined to be insignificant can be at least one order of magnitude smaller, preferably at least two orders of magnitude smaller, and still more preferably at least three orders of magnitude smaller, than the skip layer weights applied to those elements determined to be significant. In other embodiments, the skip layer may be an unweighted binary sentry layer that either includes or excludes elements of the input, without weighting. Other suitable embodiments of a skip layer are also contemplated.

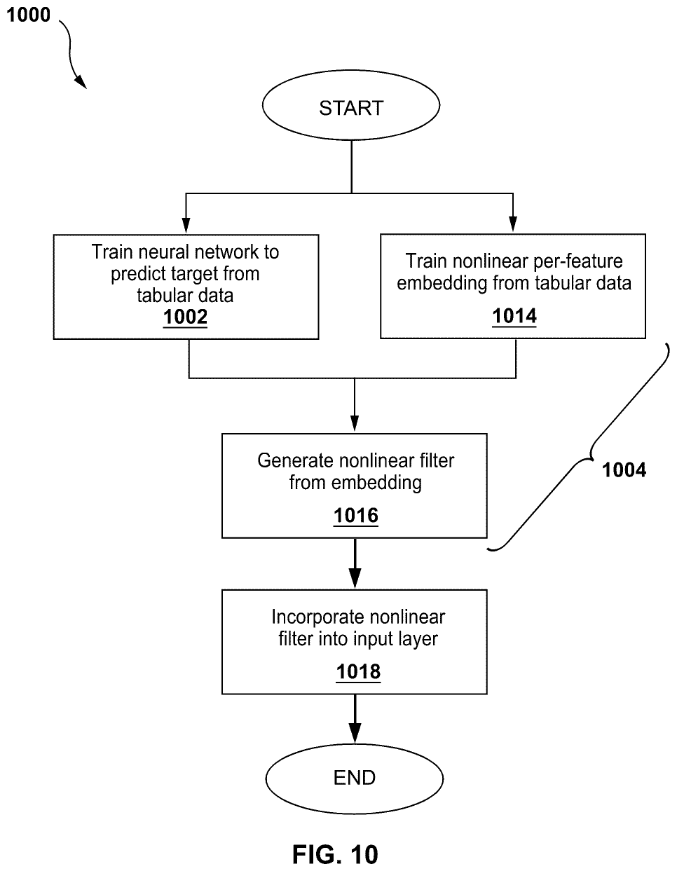

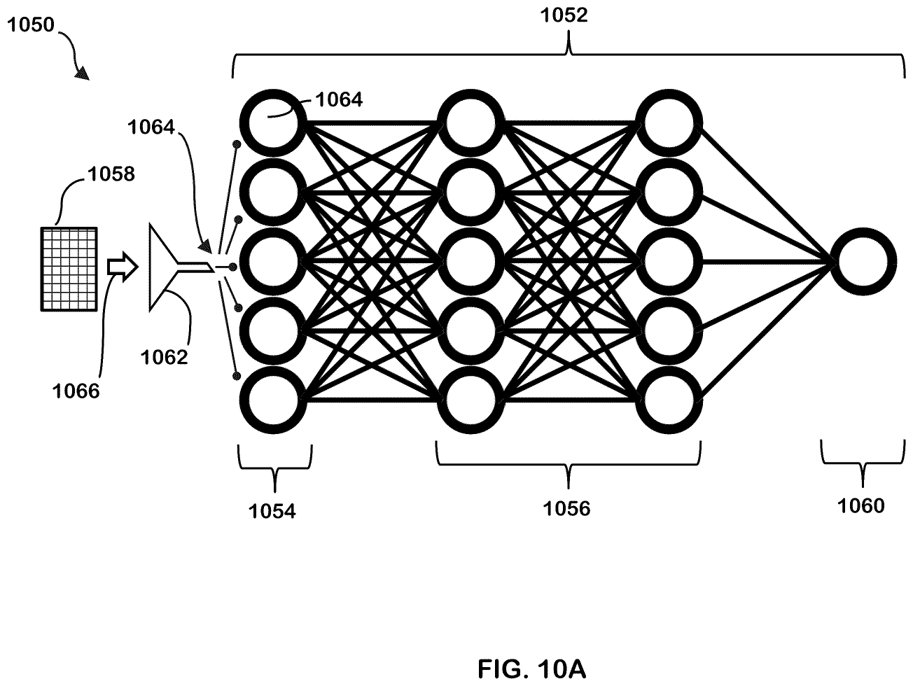

As noted above, the skip layer functions as a filter for the input into the neural network. Thus, with reference to FIG. 10, an aspect of the present disclosure comprises a method 1000 for training a neural network for processing tabular data. At step 1002, the method 1000 trains a neural network to output a target from the tabular data; this corresponds generally to step 902 in FIG. 9. At step 1014, the method 1000 trains a nonlinear per-feature embedding from the tabular data, and at step 1016, the method 1000 generates, from the nonlinear per-feature embedding trained at step 1014, a nonlinear filter that filters input of the tabular data into the neural network. Steps 1014 and 1016 together form a combined step 1004 that corresponds generally to step 904 in FIG. 9. At optional step 1018, the nonlinear filter is incorporated as an input layer of the neural network. As can be seen in FIG. 10, in the illustrated embodiment the neural network and the embedding are jointly trained; in a preferred embodiment the neural network and the embedding are jointly trained during an initial pre-training stage and a subsequent feature selection training stage.

With reference now to FIG. 10A, an illustrative computer-implemented method for processing tabular data is shown generally at 1050, and may be carried out after the training method 1000 described in the context of FIG. 10. The method 1050 maintains a neural network 1052 comprising an input layer 1054, a plurality of hidden layers 1056 having hidden layer connections and hidden layer weights for the tabular data 1058, and an output layer 1060. The neural network 1052 is trained to output a target from the tabular data 1058.

The method 1050 further maintains a nonlinear filter 1062. The nonlinear filter 1062 is generated from a nonlinear per-feature embedding trained on the tabular data 1058. The method 1050 uses the nonlinear filter 1062 to filter 1064 the input 1066 of the tabular data 1058 into the neural network 1052. Optionally, the nonlinear filter 1062 may be incorporated as an input layer of the neural network 1052, e.g. preceding the original input layer 1052. The nonlinear filter 1062, which may be generated at step 1016 of the method 1000 in FIG. 10, may be adapted to apply individual weights to respective elements of the input, e.g. apply individual weights to selected features of the tabular data. In one embodiment, the filter is adapted to exclude selected ones of the elements of the input by applying a weight of zero to those elements. Alternatively, the filter generated at step 1016 may be an unweighted binary filter adapted to either include or exclude elements of the input, without the use of weighting.

The embodiments shown in FIGS. 9, 9A, 10 and 10A are merely illustrative, and not limiting.

Benchmark datasets and performance comparisons between deep tabular models and tree-based methods have been developed. In Cherepanova et al., 2023, the authors rigorously evaluate the efficacy of various feature selection methods through their impact on the performance of subsequent deep neural network models. They construct a sophisticated benchmark comprising real-world datasets enhanced with specifically designed extraneous features—random noise, corrupted, and second-order features—to test the robustness of feature selection methods in challenging environments. One aspect of this benchmark is the comparative analysis of downstream model performances with and without feature selection. The study finds that feature selection methods, when combined with a downstream deep tabular model, can mitigate overfitting and improve model performances. The authors also propose a specialized method called Deep Lasso, designed for deep learning architectures, and the authors highlight that models trained with selected features through Deep Lasso generally outperform those trained with the full set of features or those selected by more conventional methods, particularly in scenarios involving corrupted features.

Certain experiments were conducted to assess performance of the architecture described herein, which (as described above) uses a nonlinear per-feature embedding to constrain participation of the input within the neural network, limits the ability of the neural network during pre-training and uses coordinate descent proximal gradient training that sequentially optimizes the feature selection component and the main neural network. Certain benchmark datasets from Cherepanova et al., 2023, which is incorporated herein by reference, were used.

For all experiments, the default training, validation and test split from the benchmark repository was used, which is [0.65, 0.15, 0.2]. The pre-training stage was set to be 200 epochs, and the lambda-training stage for each lambda value was 100 epochs. The patience was 20 epochs for both the pre-training stage and the lambda-training stage, so that if the lambda-training for a particular lambda value did not improve the validation loss for more than 20 epochs, the training moved to the next lambda value. For the lambda values, a sequence was generated by using linspace in NumPy (which is available at the URL https://numpy.org/doc/stable/reference/generated/numpy.linspace.html), from small lambda values (1e-5) to large lambda values (1e-2).

Hyperparameter tuning was conducted using Optuna (Akiba et al., 2019), an open source Bayesian hyperparameter optimization framework available at https://optuna.org/. For each method evaluated, hyperparameter tuning was conducted using the Optuna optimization engine for both the feature selection algorithms and the downstream models, focusing on optimizing downstream model performance. The optimal hyperparameters were determined based on validation metrics and the test metrics (Table 2) were calculated across 10 random model initializations with different seeds. For FT-transformers and MLP, the hyperparameters and their respective ranges remain consistent with those reported in Cherepanova et al., 2023. The specific hyperparameters for the architecture described herein are detailed in Table 1.

TABLE 1
Hyperparameters Tuned by Optuna and Their Ranges

| | | Step/ |
|---|---|---|
| Hyperparameter | Range | Scale |
| Number of Mixer blocks | 2 to 5 | 1 |
| MLP1 hidden dimension | 64 to 512 | 50 |
| MLP2 hidden dimension | 64 to 512 | 50 |
| Feature embedding output dimension | 8 to 32 | 2 |
| Number of bins used in PLE | 4 to 32 | 2 |
| Tau (scalar multiplied with main | 0.01 to 0.1 | Uniform |
| module output) | | |
| Normalization method in ResNet | {‘batch’, ‘layer’} | Categorical |
| ResNet dropout | 0.05 to 0.25 | Uniform |
| Main module dropout | 0.05 to 0.25 | Uniform |
| Number of ResNet layers | 2 to 5 | 1 |
| ResNet layers dimension | 8 to 32 | 1 |
| lr | 1 × 10⁻⁴ to 1 × 10⁻³ | Loguniform |
| AdamW weight decay | 1 × 10⁻⁶ to 1 × 10⁻³ | Loguniform |

The performance comparisons of the architecture described herein with different feature selection and downstream benchmark methods are shown in Table 2 below. Table 2 presents the test metrics, which as noted above were calculated across 10 random model initializations with different seeds. The results shown in Table 2 represent the best model after hyperparameter tuning. MLP in Table 2 refers to a multi-layer perception or a feed forward fully connected neural network, while FT refers to FT-Transformer. Univariate refers to the Univariate Statistical Test, which checks the linear dependence between the predictors and the target variable, and uses the ANOVA F-values to select features for classification problems and uses univariate linear regression test F-values to select features for regression problems. Lasso uses Li regularization to encourage sparsity in a linear regression model and then ranks features with respect to the magnitudes of their coefficients in the model. First-Layer Lasso (1L Lasso) extends Lasso for MLPs with multiple layers, and applies a Group Lasso penalty to the first layer parameter weights. Adaptive Group Lasso (AGL) extends the Group Lasso regularization method, applying a Group Lasso penalty to the first layer parameter weights as with 1L Lasso, but with each group of coefficients being weighted with an adaptive weight parameter, and then ranks features with respect to their grouped weights in the first layer. Random Forest (RF) is a well-known bagging ensemble of decision trees, and XGBoost is a well-known gradient boosted decision tree approach. Attention Map Importance (AM) is computed for a FT-Transformer model using one forward pass on the validation set, and Deep Lasso is noted above. For the benchmark datasets, “AL” refers to ALOI (image data), “CH” refers to California Housing (real estate data), “GE” refers to Gesture Phase Prediction (gesture phase segmentation data) and “EY” refers to Eye Movements (eye movement trajectories), all as cited in section B.1 of Cherepanova et al., 2023. Table 2 shows either negative RMSE (CH dataset) or accuracy (AL, GE, EY datasets).

The first column of Table 2 (FS & Downstream Method) lists different combinations of feature selection method and downstream models. For instance, RF+MLP means that for any given dataset, the features are first selected using Random Forest, and then a downstream model MLP is trained using only the selected features. Noise features were added to all datasets, where the number of noise features added is the same as the number of original features.

TABLE 2
Benchmarking feature selection methods for MLP and
FT-Transformer downstream models and current architecture
on datasets with random extra features

| FS & Downstream Method | AL | CH | GE | EY |
|---|---|---|---|---|
| No FS + MLP | 0.941 | −0.480 | 0.466 | 0.538 |
| Univariate + MLP | 0.96 | −0.447 | 0.515 | 0.575 |
| Lasso + MLP | 0.949 | −0.454 | 0.458 | 0.547 |
| 1L Lasso + MLP | 0.952 | −0.451 | 0.474 | 0.564 |
| AGL + MLP | 0.958 | −0.512 | 0.473 | 0.578 |
| LassoNet + MLP | 0.954 | −0.445 | 0.495 | 0.552 |
| AM + MLP | 0.953 | −0.444 | 0.498 | 0.554 |
| RF + MLP | 0.955 | −0.453 | 0.594 | 0.589 |
| XGBoost + MLP | 0.956 | −0.444 | 0.502 | 0.59 |
| Deep Lasso + MLP | 0.959 | −0.443 | 0.485 | 0.573 |
| No FS + FT | 0.959 | −0.432 | 0.500 | 0.673 |
| Univariate + FT | 0.963 | −0.424 | 0.519 | 0.700 |
| Lasso + FT | 0.952 | −0.419 | 0.489 | 0.682 |
| 1L Lasso + FT | 0.963 | −0.423 | 0.489 | 0.72 |
| AGL + FT | 0.899 | −0.42 | 0.490 | 0.701 |
| LassoNet + FT | 0.963 | −0.426 | 0.505 | 0.670 |
| AM + FT | 0.962 | −0.425 | 0.505 | 0.657 |
| RF + FT | 0.963 | −0.42 | 0.591 | 0.718 |
| XGBoost + FT | 0.963 | −0.42 | 0.572 | 0.725 |
| Deep Lasso + FT | 0.962 | −0.419 | 0.504 | 0.703 |
| Equation (11) | 0.963 | −0.413 | 0.585 | 0.696 |
| Equation (15) | N/A | −0.406 | N/A | N/A |
| (EMA Sign Modification and EMA | | | | |
| Magnitude Modification) | | | | |

As can be seen from the table, the results demonstrate the effectiveness of the architecture according to the present disclosure. Equation (15), which was only tested on the CH dataset, is also well-suited to stochastic optimization.

As can be seen from the above description, the deep learning for tabular data described herein represents significantly more than merely using categories to organize, store and transmit information and organizing information through mathematical correlations. The deep learning for tabular data is in fact an improvement to the technology of machine learning, and to the technology of neural networks for tabular data in particular, as it provides a dedicated embedding module, converting each individual feature into a high-dimensional embedding. The embeddings are directly associated with the target variable through the use of skip connections, which facilitate the learning of direct feature correlations even when these correlations are nonlinear. These skip connections enable regulation of feature influence within the neural network by serving as constraints during computation, which can improve performance of the neural network, thus solving a specific problem relating to the operation of a computer. As such, the technology described herein is confined to neural network applications for processing tabular data.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown as being executed substantially concurrently, in fact, be executed in succession, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

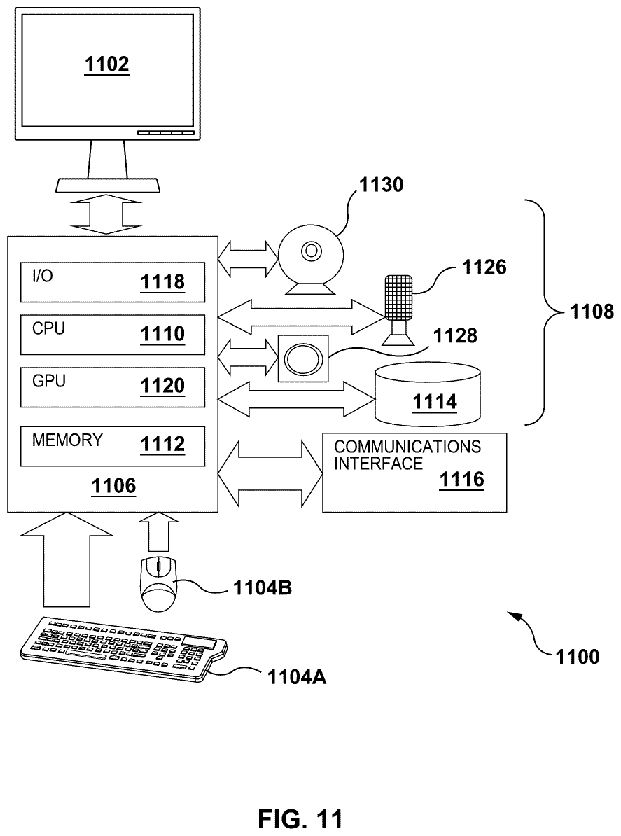

An illustrative computer system in respect of which the technology herein described may be implemented is presented as a block diagram in FIG. 11. The illustrative computer system is denoted generally by reference numeral 1100 and includes a display 1102, input devices in the form of keyboard 1104A and pointing device 1104B, computer 1106 and external devices 1108. While pointing device 1104B is depicted as a mouse, it will be appreciated that other types of pointing device, or a touch screen, may also be used.

The computer 1106 may contain one or more processors or microprocessors, such as a central processing unit (CPU) 1110. The CPU 1110 performs arithmetic calculations and control functions to execute software stored in an internal memory 1112, preferably random access memory (RAM) and/or read only memory (ROM), and possibly additional memory 1114. The additional memory 1114 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 1114 may be physically internal to the computer 1106, or external as shown in FIG. 11, or both.

The computer system 1100 may also include other similar means for allowing computer programs or other instructions to be loaded. Such means can include, for example, a communications interface 1116 which allows software and data to be transferred between the computer system 1100 and external systems and networks. Examples of communications interface 1116 can include a modem, a network interface such as an Ethernet card, a wireless communication interface, or a serial or parallel communications port. Software and data transferred via communications interface 1116 are in the form of signals which can be electronic, acoustic, electromagnetic, optical or other signals capable of being received by communications interface 1116. Multiple interfaces, of course, can be provided on a single computer system 1100.

Input and output to and from the computer 1106 is administered by the input/output (I/O) interface 1118. This I/O interface 1118 administers control of the display 1102, keyboard 1104A, external devices 1108 and other such components of the computer system 1100. The computer 1106 also includes a graphical processing unit (GPU) 1120. The latter may also be used for computational purposes as an adjunct to, or instead of, the (CPU) 1110, for mathematical calculations.

The external devices 1108 include a microphone 1126, a speaker 1128 and a camera 1130. Although shown as external devices, they may alternatively be built in as part of the hardware of the computer system 1100.

The various components of the computer system 1100 are coupled to one another either directly or by coupling to suitable buses.

The terms “computer system”, “data processing system” and related terms, as used herein, are not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 1112 of the computer 1106, or on a computer usable or computer readable medium external to the computer 1106, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

### REFERENCES

The following list of references is provided for convenience only, and without admission that any of the references constitutes prior art or is relevant to the invention as claimed.
[Akiba et al., 2019] Akiba, T., Sano, S., Yanase, T., Ohta, T., and Koyama, M. (2019). Optuna: A next-generation hyperparameter optimization framework. In Proceedings of the 25th ACM SIGKDD International Conference on Knowledge Discovery & Data Mining, pages 2623-2631.
[Arik and Pfister, 2020] Arik, S. O. and Pfister, T. (2020). Tabnet: Attentive interpretable tabular learning. arXiv preprint arXiv: 1908.07442v5.
[Borisov et al., 2021] Borisov, V., Leemann, T., Seßler, K., Haug, J., Pawelczyk, M., and Kasneci, G. (2021). Deep neural networks and tabular data: A survey. arXiv preprint arXiv: 2110.01889.
[Chen and Guestrin, 2016] Chen, T. and Guestrin, C. (2016). Xgboost: A scalable tree boosting system. In Proceedings of the 22nd ACM SIGKDD International Conference on Knowledge Discovery and Data Mining.
[Cherepanova et al., 2023] Cherepanova, V., Levin, R., Somepalli, G., Geiping, J., Bruss, C., Wilson, A., Goldstein, T., and Goldblum, M. (2023). A performance-driven benchmark for feature selection in tabular deep learning. In NeurIPS 2023 Second Table Representation Learning Workshop.
[Gorishniy et al., 2022] Gorishniy, Y., Rubachev, I., and Babenko, A. (2022). On embeddings for numerical features in tabular deep learning. In Advances in Neural Information Processing Systems (NeurIPS). Last Modified: 11 Mar. 2024.
[Gorishniy et al., 2021] Gorishniy, Y., Rubachev, I., Khrulkov, V., and Babenko, A. (2021). Revisiting deep learning models for tabular data. In Advances in Neural Information Processing Systems (NeurIPS). Last Modified: 21 Oct. 2023.
[Grinsztajn et al., 2022] Grinsztajn, L., Oyallon, E., and Varoquaux, G. (2022). Why do tree-based models still outperform deep learning on typical tabular data? In NeurIPS 2022 Datasets and Benchmarks. Last Modified: 23 May 2023.
[Hazimeh et al., 2020] Hazimeh, H., Ponomareva, N., Mol, P., Tan, Z., and Mazumder, R. (2020). The tree ensemble layer: Differentiability meets conditional computation. In Proceedings of the International Conference on Machine Learning (ICML).
[Huang et al., 2020a] Huang, X., Khetan, A., Cvitkovic, M., and Karnin, Z. (2020a). Tabtransformer: Tabular data modeling using contextual embeddings. arXiv preprint arXiv: 2012.06678v1.
[Huang et al., 2020b] Huang, X., Khetan, A., Cvitkovic, M., and Karnin, Z. (2020b). Tabtransformer: Tabular data modeling using contextual embeddings.
[Kaggle, 2021] Kaggle (2021). State of data science and machine learning 2021. https://www.kaggle.com/kaggle-survey-2021.
[Ke et al., 2017] Ke, G., Meng, Q., Finley, T., Wang, T., Chen, W., Ma, W., Ye, Q., and Liu, T.-Y. (2017). Lightgbm: A highly efficient gradient boosting decision tree. In Advances in Neural Information Processing Systems, volume 30, pages 3146-3154.
[Kossen et al., 2021] Kossen, J., Band, N., Lyle, C., Gomez, A. N., Rainforth, T., and Gal, Y. (2021). Self-attention between datapoints: Going beyond individual input-output pairs in deep learning. arXiv preprint arXiv: 2106.02584.
[Lemhadri et al., 2021] Lemhadri, I., Ruan, F., Abraham, L., and Tibshirani, R. (2021). Lassonet: A neural network with feature sparsity. Journal of Machine Learning Research, 22(127):1-29.
[Popov et al., 2020] Popov, S., Morozov, S., and Babenko, A. (2020). Neural oblivious decision ensembles for deep learning on tabular data. In Proceedings of the International Conference on Learning Representations (ICLR).
[Prokhorenkova et al., 2018] Prokhorenkova, L., Gusev, G., Vorobev, A., Dorogush, A. V., and Gulin, A. (2018). Catboost: unbiased boosting with categorical features. In Advances in Neural Information Processing Systems.
[Shwartz-Ziv and Armon, 2022] Shwartz-Ziv, R. and Armon, A. (2022). Tabular data: Deep learning is not all you need. Information Fusion, 81:84-90.
[Tolstikhin et al., 2021] Tolstikhin, I., Houlsby, N., Kolesnikov, A., Beyer, L., Zhai, X., Unterthiner, T., Yung, J., Steiner, A. P., Keysers, D., Uszkoreit, J., Lucic, M., and Dosovitskiy, A. (2021). Mlp-mixer: An all-mlp architecture for vision. In Advances in Neural Information Processing Systems (NeurIPS). Last Modified: 21 Oct. 2023.
[Zhang et al., 2022] Zhang, H., Yu, D., Yi, M., Chen, W., and Liu, T.-Y. (2022). Stabilize deep resnet with a sharp scaling τ. Machine Learning, 111 (9): 3359-3392.413

What is claimed is:

1. A computer-implemented method for training a neural network for processing tabular data, comprising:
training a neural network to output a target from the tabular data; and
training a skip layer to constrain the neural network, wherein the skip layer governs an extent to which particular features of the tabular data participate in the neural network;
characterized in that:
the skip layer is based on a nonlinear per-feature embedding for each feature of the tabular data.

2. The method of claim 1, wherein the neural network and the skip layer are jointly trained.

3. The method of claim 2, wherein the neural network and the skip layer are jointly trained during an initial pre-training stage and a subsequent feature selection training stage.

4. The method of claim 3, wherein the feature selection training stage comprises tracking an exponential moving average of each of (a) skip layer weights of the skip layer; and (b) neural network weights of the neural network.

5. The method of claim 4, wherein the exponential moving average is incorporated into a hierarchical proximal operator.

6. The method of claim 5, wherein the hierarchical proximal operator incorporates soft-thresholding.

7. The method of claim 1, wherein the skip layer is incorporated as an input layer of the neural network.

8. The method of claim 1, wherein the skip layer applies individual skip layer weights to respective ones of the features of the tabular data.

9. The method of claim 8, wherein the skip layer is adapted to exclude selected ones of the features of the tabular data by setting the respective skip layer weights for the selected ones of the features of the tabular data to zero.

10. The method of claim 1, wherein the skip layer is an unweighted binary sentry layer that either includes or excludes elements of the input.

11. A data processing system comprising at least one processor and memory coupled to the at least one processor, wherein the memory contains instructions which, when executed by the at least one processor, cause the data processing system to implement the method of claim 1.

12. At least one tangible, non-transitory computer-readable medium embodying instructions which, when executed by at least one processor of a data processing system, cause the data processing system to implement the method of claim 1.

13. A computer-implemented method for training a neural network for processing tabular data, comprising:
training a neural network to output a target from the tabular data;
training a nonlinear per-feature embedding from the tabular data; and
generating, from the nonlinear per-feature embedding, a nonlinear filter that filters input of the tabular data into the neural network.

14. The method of claim 13, wherein the neural network and the embedding are jointly trained during an initial pre-training stage and a subsequent feature selection training stage.

15. The method of claim 14, wherein the feature selection training stage comprises:
tracking an exponential moving average of each of (a) weights of the nonlinear filter and (b) weights of connections in the neural network;
wherein the exponential moving average is incorporated into a hierarchical proximal operator.

16. The method of claim 13, wherein the nonlinear filter is incorporated as an input layer of the neural network.

17. The method of claim 13, wherein the filter is adapted to apply individual weights to respective elements of the input.

18. The method of claim 13, wherein the filter is adapted to exclude selected ones of the elements of the input by applying a weight of zero to those elements.

19. The method of claim 13, wherein the filter is unweighted and binary and is adapted to either include or exclude elements of the input.

20. A data processing system comprising at least one processor and memory coupled to the at least one processor, wherein the memory contains instructions which, when executed by the at least one processor, cause the data processing system to implement the method of claim 13.

21. At least one tangible, non-transitory computer-readable medium embodying instructions which, when executed by at least one processor of a data processing system, cause the data processing system to implement the method of claim 13.
